(19) United States
(12) Patent Application Publication
(10) Pub. No.: US 2013/0300019 A1
(43) Pub. Date: Nov. 14, 2013

(54) METHOD OF MANUFACTURING POLARIZABLE ELECTRODES FOR USE IN ELECTROCHEMICAL CAPACITORS

(71) Applicants: Sergey Vladimirovich Tarasov, Saratov (RU); V. Menukhov, Moscow (RU); Igor Nikolaevich Varakin, Troitsk (RU)

(72) Inventors: Sergey Vladimirovich Tarasov, Saratov (RU); V. Menukhov, Moscow (RU); Igor Nikolaevich Varakin, Troitsk (RU)

(73) Assignee: UNIVERSAL SUPERCAPACITORS LLC, Columbus, OH (US)

(21) Appl. No.: 13/468,681

(22) Filed: May 10, 2012

(51) Int. Cl. H01G 9/145

(52) U.S. Cl. 264/105

(57) ABSTRACT

A method of manufacturing polarizable electrode plates for use in an electrochemical capacitor having a high energy storage capacity. The plates are made of a dry activated carbon and modifying agent mixture combined with a binder. The plates are manufactured by mixing and grinding the mixture, combining the mixture with the binder to form a paste, removing free water from the paste, forming work pieces of desired dimensions from the paste, drying the work pieces, and then forming electrode plates from the work pieces by rolling without the use of processing liquids.

### TECHNICAL FIELD

The present invention relates to electrochemical capacitors. More particularly, the present invention is directed to a method of manufacturing polarizable electrodes constructed of powdered activated carbon for use with electrochemical capacitors having a sulfuric acid electrolyte.

### BACKGROUND

Double electric layer (DEL) electrochemical capacitors are known in the art. In such capacitors, double electric layers are formed at the interface between the electronic conductor and the electrolyte. DEL electrochemical capacitors typically include polarizable electrodes having a current collector with an active material applied thereto. Generally, the active material of choice for such polarizable electrodes is an activated carbon material (see, e.g., W. Halliop et al., “Low Cost Supercapacitors,” Third International Seminar on Double Layer Capacitors and Similar Energy Storage Devices, Florida, 1993, U.S. Pat. No. 4,697,224, cl., H 01 G 9/04, 1987).

Different methods exist to manufacture polarizable electrodes made from activated carbon materials. One such method uses carbon cloth. Carbon cloth is manufactured by the carbonization and activation of different woven and non-woven materials based on cellulose, viscose or other materials. Although effective in creating polarizable electrodes, carbon cloth is very expensive.

The active materials of polarizable electrodes based on carbon powders are less expensive and may be manufactured by relatively simple methods, for example, by extruding or rolling. At the same time, available carbon powder manufacturing methods have various drawbacks such as, for example, many manufacturing process stages, and the required use of process liquid additives (e.g., hydrocarbons, alcohols and their mixtures) that are removed from an active material in the course of and after its manufacture, thereby increasing production hazards and contaminating the environment.

Various methods of electrode sheet manufacturing are also known. In one known technique, an electrode sheet is formed from granules containing electrochemically active material, conductive additives, and binders bonded to a foil collector, so that the resulting sheet has a bent or cylindrical form similar to the capacitor. The components are first mixed to ensure the binder forms a fiber structure. Thereafter lumps are formed from the ingredients and the lumps are subsequently crushed into granules and formed into an electrode sheet. The electrode sheet is then connected with a metal foil collector (preferably Al). The final (flexible strip) electrode is capable of being bent without cracking and may be formed into a cylindrical shape.

This manufacturing technique has been described in the art specifically with respect to the manufacture of a flexible strip electrode for use in capacitors having a cylindrical shape and a non-aqueous electrolyte. Such an electrode contains a high amount of binder, e.g., more than 6% TEFLON. While such a percentage of binder material is acceptable for use with a non-aqueous electrolyte, such a high percentage of binder material results in the inability of an aqueous electrolyte to fully wet the electrode. As a result, such an electrode is incompatible with an electrochemical capacitor having an aqueous electrolyte; such as an electrochemical capacitor of the present invention.

Other related methods of electrode manufacture are also known. For example, a method of manufacturing a hydrophobic carbon electrode plate for use on a fuel cell is known in the art. In this manufacturing technique, carbon fibers are mixed with a bonding material to form plates, which are then dried. The dried plates are subsequently immersed in a diluted solution containing a hydrophobic material. The plates are then sintered at approximately 500° C. to fix the hydrophobic material to the plate and at the same time to remove the bonding agent from the plate through oxidation.

Activated carbon may not used to manufacture electrode plates in this manner. Specifically, heating activated carbon plates to a temperature of around 500° C. would oxidate the carbon and the resulting characteristics of the electrode plate would be detrimentally affected. In addition, such heating would remove nearly all of the moisture from the plates, making the below-described inventive technique of rolling without the use of process liquids impossible.

Semi-metallic electrode manufacturing techniques are also known. For example, it is known in the art to manufacture a carbon electrode containing copper or a copper compound. In such an electrode manufacturing technique, the copper is introduced by treating carbonized ion-exchange polymers with a solution containing copper ions followed by a thermal treatment at about 800° C. in an inert atmosphere. The product is then rinsed using hydrochloric acid and de-ionized water.

It is known that the activated carbon adsorbs ions of heavy metal very well, but such ions are not integrated in the carbon's structure; however, the claimed method does not require such integration.

Specific electrode forming methods are also known. For example, it is known that an electrode for a DEL electrochemical capacitor may be formed by extruding a paste from a carbon material, adding polytetrafluoroethylene (PTFE) and auxiliary petrochemical additives in an amount of about 20-200% of the mass of the carbon material, and rolling the material into sheets having a thickness of between about 0.005 mm to 0.25 mm.

There are several drawbacks associated with this manufacturing method. One such drawback is the use of petrochemical additives during various stages of production. Useable petrochemical additives are either inflammable or noxious substances, or both. For example, glycerol has a low volatility and is minimally noxious. However, when heated to the temperatures required by the rolling and extrusion steps, glycerol partially decomposes into volatile, flammable, and noxious components.

In addition to this drawback, such a manufacturing method may not be useable in the manufacture of electrodes made with activated carbon because such petrochemical additives would be absorbed by the activated carbon and the presence of these absorbed organic molecules would reduces the specific capacitance of the carbon. The absorbed organic molecules may be removed, but only with great difficulty. In this regard, since the additives should be removed from the activated carbon during the manufacturing process, additional protection for the manufacturing personnel is required and the removed petrochemical additives may result in contamination of the environment—thereby requiring special neutralization arrangements or the trapping of evolved vapors.

In another known method of electrode plate manufacturing, a dry active material is mixed with water and a surface active substance (SAS) to produce a paste. The paste is then divided into portions (chunks) having a size of about 0.5 inches or less. The portions are then dried to a humidity of about 3% and subsequently ground into powder. The powder is then distributed on a metal gauze (preferably Al) and thereafter calendered to form a cathode layer. It is then heated to a temperature of between 295°-325° C. and the resulting electrodes are then cut and calendered to a desired thickness. Electrodes obtained from this process are designed for use in galvanic cells with non-aqueous electrolytes and an anode made of an alkali metal.

This technique uses an active material and carbon, but not activated carbon. The use of activated carbon would prevent the use of a SAS material, as activated carbon absorbs SAS very well and SAS is extremely difficult to remove therefrom. In addition, simply mixing a dry active material in water makes it very difficult to obtain a high-quality paste with similar particle sizes. In this regard, it should be noted that problems arise if the particles of the mixed material are significantly different in size and density (e.g., sizes from 1 μm to 0.5 mm and density from 1 to 8 g/cm³). A significantly differing size and density decreases the ability to evenly distribute the particles by volume.

Additionally, this known manufacturing technique fails to take into account the other manufacturing requirements associated with the use of activated carbon. For example, the aforementioned known technique discloses forming portions of paste having a size of about 0.5 inches or less, which paste portions are subsequently ground into a powder. When using activated carbon, however, high-quality electrode strips or plates are difficult to obtain with paste portions of less than about 0.039 inches without the use of process liquids and plasticizers.

It should be further understood that when using activated carbon to manufacture plates for use in electrochemical capacitors, heating to a temperature of 295° C. or higher as described by this known technique is unacceptable due to resulting oxidation at the surface. The aforementioned manufacturing technique also requires an additional calendaring of the electrode to the obtain the desired thickness.

### SUMMARY OF THE GENERAL INVENTIVE CONCEPT

The present invention is directed to a method for manufacturing a negative carbon electrode for use in an electrochemical capacitor, wherein the manufacturing method has a minimum number of simple steps. The technological operations may be mechanized and automated, enhancing safety and making it possible to increase the volume specific capacitance of the electrode. Electrodes manufactured by a method of the present invention may be formed as plates. While in no way so limited in use, electrochemical capacitors utilizing polarizable electrodes manufactured according to the present invention may be used in emergency power supplies or in to contribute additional electrical energy in power quality maintenance devices.

In exemplary embodiments of an activated carbon electrode manufacturing process of the present invention, the mixing of the components is typically performed in two stages, the first stage of which may be combined with a grinding process and may include the addition of modifying additives to form a dry mixture.

During the second stage, the dry mixture from the first stage may be impregnated with an aqueous slurry of a polymer binder, for example, polytetrafluoroethylene (PTFE), to form an aqueous slurry. Free water is thereafter preferably removed from the slurry.

The filtered carbon mass material may be distributed in even layers on a solid base. The thickness of the distributed layers may be provided as a thickness that is greater than the calculated thickness of the work piece to be produced by the subsequent rolling of the plates to account for shrinkage during the drying process. A work piece(s) of desired size is cut from the distributed layer(s), and may also be oversized to account for shrinkage.

After being cut to a desired size, the electrode active mass work piece is dried and subsequently cooled. After drying, and preferably immediately after drying (or drying and cooling), the work piece is passed through rolls to produce an electrode plate of desired thickness.

### DETAILED DESCRIPTION OF THE EXEMPLARY EMBODIMENT(S)

In an exemplary embodiment of manufacturing method of the present invention, the mixing of the components is performed in two stages, the first stage of which may be combined with a grinding process. During the first stage, the active carbon mass is mixed and ground. The carbon mass may include but is not limited to active carbon and modifying additives, which may be combined to form a dry mixture.

The active carbon and modifying additives generally have significantly different particle densities, particle sizes, and particle shapes. Therefore, to provide an even distribution of materials in the mixture volume, vibration may be used. One employable and exemplary vibroimpact effect may have an amplitude of about 10-50 mm and a frequency of about 10-100 Hz, and may be applied in two mutually perpendicular directions. Under the vibrating influence, the active carbon and modifying additive particles move in the work space along spiral trajectories. This spiral trajectory provides for an even distribution of particles throughout the volume of the obtained mixture. To further assist the mixing process and obtain an even distribution of particles, the mixture is preferably ground simultaneously with the mixing process.

During the second stage, the dry mixture from the first stage may be impregnated with an aqueous slurry of a polymer binder, for example, polytetrafluoroethylene (PTFE) in an amount equivalent to approximately 3-7% of the dry mixture. The ratio of the dry mixture to water in the work space is approximately 1:9 to 1:14 by weight. The impregnation proceeds, preferably with intense mixing utilizing a high speed mixer. After impregnation, the mixture becomes an aqueous slurry containing about 10-15% content of the dry substance. Excess water is thereafter removed from the slurry.

As used herein, free water is intended to mean water that can be removed from the slurry without any external influence. For example, excess water may be removed by simply filtering the slurry through a cloth or paper filter, without the use of external influences. The removal may also be performed by means of a vacuum filter at a pressure of about 50-150 mbars. Through such filtration techniques, it is possible to remove approximately 60% of the mass of the water used. After filtration is complete, the slurry becomes a paste having a consistency of thick dough, with moisture content of about 270-300%. If the moisture of the paste exceeds 300%, cracks in random directions and shapeless chunks may form during the drying process, instead of work pieces of rectangular shape and assigned dimensions. By removing water from the mixture, the energy required to dry the mixture is reduced.

The filtered carbon mass material may be distributed in even layers on a solid base. One example of such a solid base is the bottom of a metal tray of calculated dimensions. The thickness of the distributed layers may be 30-45% greater than the calculated thickness of the work piece to be produced by the subsequent rolling of the plates to account for shrinkage during the drying process. After the carbon mass material is spread to the desired thickness, slits are preferably made therethrough to delineate the perimeter of the work piece that will become an electrode plate. The slits may be made to produce a work piece with a rectangular shape, or any shape desired. The slits may be made with various tools, including but not limited to thin blades, punches, and other tools capable of cutting through the carbon mass.

As with the thickness of the carbon mass material, the work pieces may be cut to be 30-45% greater in size (e.g., length and width, circumference, etc.) than the calculated size needed, due to shrinkage during the drying process. The slits are preferably made so as to produce no visible trace in the form of the cut. As such, the surface of the mass may be made to appear to be uniform with no appreciable space between adjacent work pieces when multiple work pieces are made concurrently.

After being cut to a desired size, the electrode active mass work piece is dried. The drying process is preferably monitored to ensure the desired shape is being maintained and to guard against cracking. The work piece is dried in/by an oven or other suitable apparatus at a temperature of between about 140°-180° C. for between approximately 0.5 to 2.0 hours. Although a considerable portion of water has already been removed from the work piece, the paste forming the work piece still retains its plasticity. As the paste continues to dry, the work piece shrinks. When multiple work pieces are cut from a single mass of material, continuing shrinkage causes the mass to break along the slits previously cut therein into individual work pieces, and a noticeable space forms between each work piece. At this point in the drying process, the work pieces are still flexible despite the loss of water.

The drying temperature is then lowered from the initial 140°-180° C. temperature to approximately 110°-130° C. over a period of between about 0.2-1.0 hours. This decrease in temperature is advisable to ensure that any further shrinkage proceeds in a slow and even manner so as to avoid cracking. The work piece is then dried at this lower temperature for an additional 6-10 hours.

The temperature difference between locations in the drying space preferably does not exceed more than about 5°-10° C. This may be achieved by circulating the air in the drying volume. To speed up the drying process, wet air from the drying environment may be partially removed.

Once the elevated temperature drying cycle is complete, the work piece is allowed to cool. The post-drying cool-down mode is not associated with any particular conditions or limitations.

Preferably, the dried work piece retains approximately 8-10% humidity by mass after the drying process, and has appropriate compressibility.

After drying, and preferably immediately after drying (or drying and cooling), the work piece is passed through two rolls on two mutually perpendicular axles. Two pairs of rolls may be used. No auxiliary liquid is used during the rolling process.

The width of the rolling strip in the rolls is preferably limited to ensure that the resulting plate is as close as possible to the desired dimensions. During the rolling process, the carbon mass may flow along the rolling axle, and may also flow transversely thereto.

The squeeze value produced by the rollers during a first run is equal to between approximately 10.0-12.5. The squeeze value is defined as the ratio of the thickness of the work piece as it enters the rolls to the thickness of the work piece after passing through the rolls. The squeeze value of a second rolling run is preferably limited to a value of between about 1.5-2.0. The temperature of the rolls during the second run is caused to be approximately 110°-130° C. The heating of the rolls and the decrease in the squeeze value during the second rolling run makes it possible to preserve the desired porosity of the resulting electrode plate, to obtain a plate of desired thickness with acceptable scattering (about ±0.05 mm), and to eliminate a calendaring operation.

In another exemplary embodiment of the present invention, copper oxide is introduced into the active mass material paste in an amount of between about 1-15%. The addition of copper oxide makes it possible to increase the specific volume capacitance of the negative electrode created by the manufacturing method by approximately 1.2-1.5 times, and considerably improves the rate at which the electrode plate is impregnated by the electrolyte.

Specific example(s):

### Example 1

In one particular exemplary embodiment of the present invention, a dry carbon mixture includes, but is not limited to: 75% wood activated coal of grade OU GOST 4453-74; 10% copper oxide (GOST 16530-79 “chda”); 8% industrial carbon (black carbon) of grade P267, TU 38 11547-86; 8% black carbon (Ketjenblack EC 300J); 4% thermo extended graphite (TU 5728-006-115990737); and 3% polytetrafluorethylene (F-4D TU 6-05-1246-81).

The carbon mixture, minus the PTFE, is then vibrated for approximately 30 minutes to mix and grind the components. The dry carbon mixture is then loaded into a high speed rotor mixer, where the PTFE is added. Diluted water is also added to the rotor mixer in a ratio of about 1:20 to the PTFE slurry. The mixture is then mixed for approximately 15 minutes. Although a rotor mixer is used, any machine capable of mixing the dry carbon mixture and PTFE slurry may be used.

The resultant mixture is then be poured into a tray that also serves as a vacuum filter. The excess water is removed at a pressure of approximately 65 mbar for about one minute. The remaining paste in the tray is divided into workpieces of a desired shape and size, as described above, and the tray is subsequently transferred to a drying chamber.

The work pieces are held in the drying chamber at a temperature of about 160° C. for a period of approximately one hour. The temperature is then lowered from 160° C. to about 125° C. over a period of approximately thirty minutes. The heating chamber remains at this temperature for about an additional 7 hours. After this period of reduced temperature drying, the heating chamber, and the work pieces, are allowed to cool.

The resultant work pieces formed on the tray may have a thickness of approximately 30-35 mm. The moisture of one set of exemplary work pieces produced by this method was determined to be approximately 8.7% as measured by an MA-30 instrument at 150° C.

The dried work pieces are then rolled in two, two-roll rolling cages. The dried work pieces may be rolled twice. The first rolling run may be performed at 3.4 mm bite (10.3 squeeze) and the second run at a 2.15 mm bite (1.6 squeeze). The temperature of the rolls during the second run was approximately 115° C. The direction of rolling in the second run may be perpendicular to the direction of the rolling in the first run. The thickness of the rolled plates produced according to this example was approximately 2.19-2.21 mm. The length and width of the plates was 200 mm and 150 mm, respectively. The samples manufactured in accordance with Example 1 are referred to in Table 1 below as “Plate 1”.

### Example 2

In Example 2, plates were manufactured in accordance with the method described in Example 1, but without any copper oxide in the paste. The samples manufactured in accordance with Example 2 are referred to in Table 1 below as “Plate 2”.

The tear resistance and bending tests of the samples produced in this manner showed that the parameters thereof are in fact identical for the “Plate 1” and “Plate 2” electrode plates.

The time of absorption of the electrolyte's drop in the plates was determined. In order to evaluate the specific capacitance thereof, Plate 1 and Plate 2 samples were tested in electrochemical elementary cells. The time of absorption, the specific capacitance, and other characteristics of the sample plates are shown in Table 1 below.

TABLE 1

| | | | | | Ab- |
|---|---|---|---|---|---|
| | Capacitance, | Capacitance, | Rspec, | Density, | sorption |
| Sample | (F/cm³) | (F/g) | (Ohm * cm) | (g/cm³) | time (min) |
| Plate 1 | 247 | 518 | 6.19 | 0.50 | 10-15 |
| Plate 2 | 155 | 549 | 6.76 | 0.39 | 30-40 |

What is claimed is:

1. A method for manufacturing electrode plates for an electrochemical capacitor polarizable electrode:
preparing a mixture of activated carbon powder, a modifying agent, and a binder;
combining the mixture with water to create a paste;
distributing an amount of the paste onto a hard surface in a desired thickness;
removing free water from the paste;
forming the paste into a work piece;
drying the work piece at a temperature of about 110° C. to about 180° C. for approximately 7.5 hours to about 12.5 hours; and
forming the work piece into an electrode plate by rolling the work piece between rotating rolls until a plate of desired thickness is formed.

2. The method of claim 1, wherein mixing of the activated carbon powder, modifying agent, and binder occurs in two stages.

3. The method of claim 2, wherein the activated carbon powder and modifying agent are dry mixed in a first stage.

4. The method of claim 3, further comprising simultaneously grinding the activated carbon powder and modifying agent during mixing.

5. The method of claim 4, wherein during the combined mixing/grinding operation, the activated carbon powder and modifying agent components are subjected to a vibratory impact effect with an amplitude of between about 10-50 mm and a frequency of between about 10-100 Hz in the vertical and horizontal directions.

6. The method of claim 4, wherein vibratory impact effect causes particles of the activated carbon powder and modifying agent to move along spiral trajectories.

7. The method of claim 3, wherein the dry mixed activated carbon powder and modifying agent components are wetted by the binder in a second stage.

8. The method of claim 7, wherein the dry mixture of the activated carbon powder and modifying agent is wetted by intense mixing with an aqueous slurry of a PTFE binder, the amount of PTFE binder being approximately 3-7% PTFE in terms of the dry components.

9. The method of claim 1, wherein the paste has a moisture content of between about 270-300% by mass.

10. The method of claim 1, wherein more than one modifying agent is used and the modifying agents are combined in a mixture selected from the group consisting of: a conductive industrial carbon, an oxide of a metal, and thermally and chemically treated graphite (TCG); an activated industrial carbon, an oxide of a metal, and TCG; a conductive industrial carbon, an activated industrial carbon, and TCG; and a mixture of all of these modifying agents.

11. The method of claim 1, wherein a rectangular work piece is cut from the paste, with the dimensions of the work piece being approximately 30-45% greater than the desired dimensions of the finished work piece to account for shrinkage during drying.

12. The method of claim 1, wherein the boundaries of the work piece are delineated by grooving, punching or stamping slits in the distributed paste.

13. The method of claim 1, wherein the work piece is dried in the following steps:
heating the work piece to a temperature of between about 140°-180° C. over a period of approximately 0.5-2.0 hours;
maintaining the work piece at a temperature of between about 140°-180° C. for a period of between approximately 0.5-2.5 hours;
cooling the work piece to a temperature of between about 110°-130° C. over a period of approximately 0.5-1.0 hours; and
maintaining the work piece at a temperature of between about 110°-130° C. for a period of approximately 6-7 hours.

14. The method of claim 1, wherein the residual moisture in the dried work piece is between approximately 8-10% by mass.

15. The method of claim 1, wherein the work piece is passed through the rolls in two runs and in two mutually perpendicular directions, with no use of any process liquids.

16. The method of claim 15, wherein during the first of the two runs the squeeze value associated with rolling the work piece is between about 10.0-11.5, and in the second of the two runs the squeeze value associated with rolling the work piece is between about 1.2-1.5.

17. A method for manufacturing electrode plates for an electrochemical capacitor polarizable electrode:
mixing a dry mixture of an activated carbon powder and a modifying agent while simultaneously grinding the mixture;
impregnating the ground dry mixture with a binder in the form of an aqueous slurry to thereby create a paste;
distributing an amount of the paste onto a hard surface designed to restrain the paste such that the paste can be distributed to a desired thickness;
removing free water from the paste without any external influence;
forming the paste into a work piece by cutting the paste to delineate the edges of the work piece;
drying the work piece at an elevated temperature of about 110° C. to about 180° C. for approximately 7.5 hours to about 12.5 hours, wherein said dried workpiece retains approximately 8-10% humidity by mass after the drying process and forming the work piece into an electrode plate by rolling the work piece between rotating rolls until a plate of desired thickness is formed.

18. The method of claim 17, wherein the modifying agent is PTFE in an amount equal to approximately 3-7% of the dry substance and the dry mixture is impregnated by the aqueous slurry using intense mixing.

19. The method of claim 17, wherein more than one modifying agent is used and the modifying agents are combined in a mixture selected from the group consisting of: a conductive industrial carbon, an oxide of a metal, and thermally and chemically treated graphite (TCG); an activated industrial carbon, an oxide of a metal, and TCG; a conductive industrial carbon, an activated industrial carbon, and TCG; and a mixture of all of these modifying agents.

20. The method of claim 17, wherein a rectangular work piece is cut from the paste, with the dimensions of the work piece being approximately 30-45% greater than the desired dimensions of the finished work piece to account for shrinkage during drying.

21. The method of claim 17, wherein the work piece is dried in the following steps:
heating the work piece to a temperature of between about 140°-180° C. over a period of approximately 0.5-2.0 hours;
maintaining the work piece at a temperature of between about 140°-180° C. for a period of between approximately 0.5-2.5 hours;
cooling the work piece to a temperature of between about 110°-130° C. over a period of approximately 0.5-1.0 hours; and
maintaining the work piece at a temperature of between about 110°-130° C. for a period of approximately 6-7 hours.

22. The method of claim 17, wherein the residual moisture in the dried work piece is between approximately 8-10% by mass.

23. The method of claim 1, wherein the work piece is passed through the rolls in two runs and in two mutually perpendicular directions, with no use of any process liquids.

24. The method of claim 15, wherein during the first of the two runs the squeeze value associated with rolling the work piece is between about 10.0-11.5, and in the second of the two runs the squeeze value associated with rolling the work piece is between about 1.2-1.5.

25. A method for manufacturing electrode plates for an electrochemical capacitor polarizable electrode:
mixing a dry mixture of an activated carbon powder and a modifying agent in a first stage by subjecting the mixture to a vibratory impact effect that causes particles of the activated carbon powder and modifying agent to move along spiral trajectories;
simultaneously grinding the mixture during mixing;
subjecting the activated carbon powder and the modifying agent to a vibratory impact with an amplitude of between about 10-50 mm and a frequency of about 10-100 Hz in the vertical and horizontal direction;
impregnating the ground dry mixture with a PTFE binder in the form of an aqueous slurry through intensive mixing to thereby create a paste, the PTFE binder being approximately 3-7% PTFE in terms of dry components;
distributing an amount of the paste onto a hard surface designed to restrain the paste such that the paste can be distributed to a desired thickness;
removing free water from the paste by filtering, said paste having a moisture content of between about 270-300% by mass after the removal of the free water;
forming the paste into a work piece by cutting the paste to delineate the edges of the work piece, the dimension of the work piece being approximately 30-45% greater than the desired dimension of a finished work piece;
drying the work piece by heating the work piece to a temperature of between about 140°-180° C. over a period of approximately 0.5-2.0 hours, maintaining the work piece at a temperature of between about 140°-180° C. for a period of between approximately 0.5-2.5 hours, cooling the work piece to a temperature of between about 110°-130° C. over a period of approximately 0.5-1.0 hours, and maintaining the work piece at a temperature of between about 110°-130° C. for a period of approximately 6-7 hours, wherein said work piece retains approximately 8-10% humidity by mass after the drying process; and
forming the work piece into an electrode plate by rolling the work piece between rotating rolls with no use of any process liquids and in at least two separate runs until a plate of desired thickness is formed, the squeeze value associated with rolling the work piece in the first of the two runs being between about 10.0-11.5, and the squeeze value associated with rolling the work piece in the second of the two runs being between about 1.2-1.5.
